(19) United States
(12) Patent Application Publication
(10) Pub. No.: US 2013/0159688 A1
(43) Pub. Date: Jun. 20, 2013

(54) ELECTRONIC DEVICE AND METHOD OF SETTING REMOVAL POLICY OF USB DEVICE

(71) Applicants: QUAN HE, Shenzhen City (CN); MING-YI CHEN, Shenzhen City (CN)

(72) Inventors: QUAN HE, Shenzhen City (CN); MING-YI CHEN, Shenzhen City (CN)

(73) Assignees: HON HAI PRECISION INDUSTRY CO., LTD., Tu-Cheng (TW); HONG FU JIN PRECISION INDUSTRY (ShenZhen) CO.,LTD., Shenzhen City (CN)

(21) Appl. No.: 13/587,944

(22) Filed: Aug. 17, 2012

(30) Foreign Application Priority Data
Dec. 17, 2011 (CN) 201110424477.9

(51) Int. Cl. G06F 9/00

(52) U.S. Cl. 713/1

(57) ABSTRACT

A method for setting removal policy of a USB device includes: obtaining device information of a USB device connected to a USB port when the electronic device is started up and on a BIOS process; comparing the obtained device information with device information stored in a storage unit to determine whether the obtained device information matches one of the device information stored in the storage unit, thus producing a comparison result; and setting removal policy of the USB device connected to the USB port according to the comparison result.

### BACKGROUND

1. Technical Field

The present disclosure relates to electronic devices and, particularly, to an electronic device and a method for setting removal policy of USB device.

2. Description of Related Art

Nowadays, electronic devices, such as computers, installed with Windows 7 operating system are more and more popular. Usually, in the Windows 7 operating system, different universal serial bus (USB) devices, such as USB mice, USB keyboards, USB flash drives are set with different removal policies. Usually, the removal policies include setting the USB device as an internal device or an external device. When one USB device is set as an internal device, the electronic device only can identify the USB device when the USB device is connected to an internal port. Therefore, a USB port of the electronic device for being connected to a USB device categorized an internal device should be set as the internal port accordingly by a user, which is inconvenient.

An electronic device and a method for setting removal policy of USB device, to overcome the described limitations is needed.

### BRIEF DESCRIPTION OF THE DRAWINGS

Many aspects of the present disclosure are better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a block diagram of an electronic device for setting removal policy of USB device, in accordance with an exemplary embodiment.

FIG. 2 is flowchart illustrating a method for setting removal policy of USB device, in accordance with an exemplary embodiment.

### DETAILED DESCRIPTION

Embodiments of the present disclosure will be described with reference to the accompanying drawings.

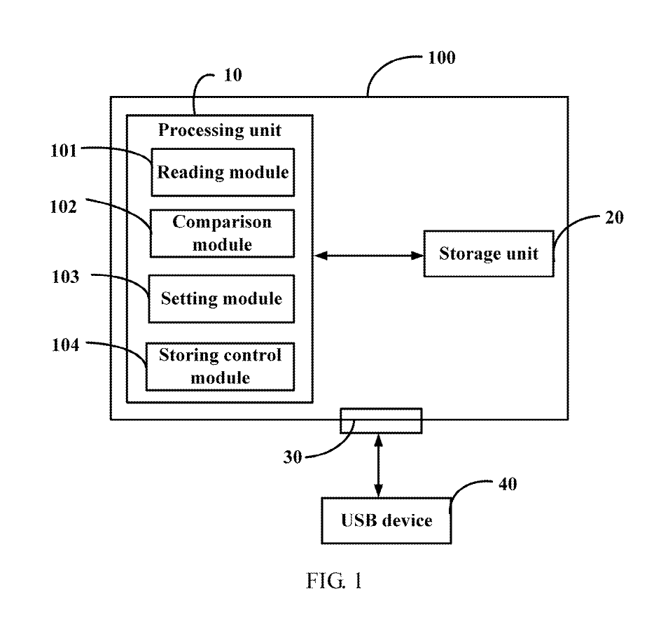

Referring to FIG. 1, an electronic device 100 for setting removal policy of USB device is illustrated. The electronic device 100 includes a processing unit 10, a storage unit 20, and at least one universal serial bus (USB) port 30.

Each of the at least one USB port 30 is used to connect a USB device 40. The USB device 40 can be a USB mouse, a USB keyboard, or a USB flash drive, for example. The storage unit 20 stores device information of a number of USB devices 40. The device information can be a vendor identity number, or a product identity number, for example. Each device information corresponds to only one USB device 40 and is used to identify the corresponding USB device 40. In the embodiment, the electronic device 100 can be a desktop computer, a portable computer, or a tablet computer running a Windows 7 operating system. The number of USB device information stored in the storage unit 20 can be any suitable number.

The processing unit 10 includes a reading module 101, a comparison module 102, and a setting module 103.

The reading module 101 is used to obtain device information of one USB device 40 connected to one of the at least one USB port 30 when the electronic device 100 is started up and in a basic input output system (BIOS) process.

The comparison module 102 is used to compare the obtained device information with the device information stored in the storage unit 20, and determines whether the obtained device information matches the device information stored in the storage unit 20, thus produces a comparison result.

The setting module 103 is used to set removal policy of the USB device 40 connected to the USB port 30 according to comparison results produced by the comparison module 102. In detail, when the device information of the USB device 40 matches the device information stored in the storage unit, the setting module 103 sets the USB device 40 as an internal device and sets the corresponding USB port 30 connected to the USB device 40 as an internal port. When the device information of the USB device 40 does not match any devices information stored in the storage unit 20, the setting module 103 sets the USB device 40 as an external device and sets the corresponding USB port 30 connected to the USB device 40 as an external port.

In the embodiment, the function of the setting module 103 described above is executed when the electronic device 100 is in an advanced configuration and power management interface (ACPI) process.

In the embodiment, the processing unit 10 also includes a storing control module 104. The storing control module 104 is used to store device information of a USB device 40 into the storage unit 20 in response to user operation. The reading module 101, the comparison module 102, and the setting module 103 execute the function as described above, and then the USB device 40 is set as the internal device accordingly. Therefore, if a user wants to set one USB 40 as the internal device, the user only needs to store the device information of the USB device 40 into the storage unit 20. The USB device 40 accordingly can be identified as the internal device when the USB device 40 is connected to any USB port 30.

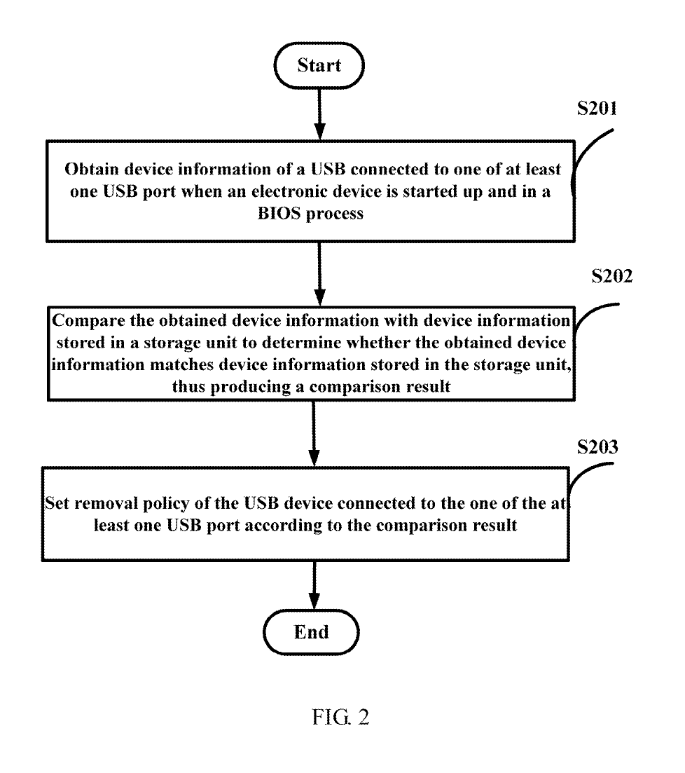

Referring to FIG. 2, a flowchart illustrating a method for setting removal policy of a USB devices is shown. The method is applied in the electronic device 100 as shown in FIG. 1. In step S201, the reading module 101 obtains device information of the USB device connected the one of the at least one USB port 30 when the electronic device 100 is started up and in a basic input output system (BIOS) process.

In step S202, the comparison module 102 compares the obtained device information with the device information stored in the storage unit 20, and determines whether the obtained device information matches the device information stored in the storage unit 20 of one of the number of USB devices 40.

In step S203, the setting module 103 sets removal policy of the USB device 40 connected to the USB port 30 according to the comparison result produced by the comparison module 102. For example, when the obtained device information of the USB device 40 matches the device information stored in the storage unit 20, the setting module 103 sets the USB device 40 as an internal device and sets the corresponding USB port 30 connected to the USB device 40 as an internal port. When the obtained device information of the USB device 40 does not match the device information stored in the storage unit 20, the setting module 103 sets the USB device 40 as an external device and sets the USB port 30 connected to the USB device 40 as an external port.

In the embodiment, the method can further include a step: the storing control module 104 stores the device information of a USB device 40 into the storage unit 20 in response to the user operation.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being exemplary embodiments of the present disclosure.

What is claimed is:

1. An electronic device for setting removal policy of USB device, comprising:
a storage unit storing device information of a plurality of USB devices;
at least one universal serial bus (USB) port, configured to connect to at least one USB device; and
a processing unit comprising:
a reading module, configured to obtain device information of a USB device connected to one of the at least one USB port when the electronic device is started up and in a basic input output system (BIOS) process;
a comparison module, configured to compare the obtained device information with the device information stored in the storage unit to determine whether the obtained device information matches the device information stored in the storage unit of one of the plurality of USB devices, thus producing a comparison result; and
a setting module, configured to set removal policy of the USB device connected to the one of the at least one USB port according to comparison result produced by the comparison module.

2. The electronic device according to claim 1, wherein the setting module sets the USB device as an internal device and sets the corresponding USB port connected to the USB device as an internal port when the device information of the USB device matches the device information stored in the storage unit of one of the plurality of USB devices.

3. The electronic device according to claim 2, wherein the setting module sets the USB device as an external device and sets the corresponding USB port connected to the USB device as an external port when the device information of the USB device does not match any device information stored in the storage unit.

4. The electronic device according to claim 1, further comprising a storing control module, wherein the storing control module is configured to store the device information of the USB device into the storage unit in response to user operation.

5. The electronic device according to claim 1, wherein the device information is a vendor identity number or a product identity number of the USB device.

6. The electronic device according to claim 1, wherein the electronic device is one selected from the group consist of a desktop computer, a portable computer, and a tablet computer running a Windows 7 operating system.

7. A method for setting removal policy of a USB device, the method is applied in an electronic device of claim 1, the electronic device comprises:
a storage unit storing device information of a plurality of USB devices;
at least one universal serial bus (USB) port, configured to connect to at least one USB device;
the method comprising:
obtaining device information of a USB connected to one of the at least one USB port when the electronic device is started up and on a basic input output system (BIOS) process;
comparing the obtained device information with the device information stored in the storage unit to determine whether the obtained device information matches the device information stored in the storage unit of one of the plurality of USB devices, thus producing a comparison result; and
setting removal policy of the USB device connected to the one of the at least one USB port according to the comparison result.

8. The method according to claim 7, further comprising:
storing the device information of the USB device into the storage unit in response to user operation.

9. The method according to claim 7, wherein the step of “setting removal policy of the USB device connected to the one of the at least one USB port according to the comparison result” comprises:
Setting the USB device as an internal device and setting the corresponding USB port connected to the USB device as an internal port when the device information of the USB device matches the device information stored in the storage unit of one of the plurality of USB devices; and
setting the USB device as an external device and setting the corresponding USB port connected to the USB device to an external port when the device information of the USB device does not match any device information stored in the storage unit.
